(19) United States
(12) Patent Application Publication
(10) Pub. No.: US 2006/0249673 A1
(43) Pub. Date: Nov. 9, 2006

(54) Ims systems

(76) Inventors: James Breach, Hertfordshire (GB); Paul Grant Wynn, Essex (GB)

Correspondence Address: FOLEY AND LARDNER LLP;SUITE 500, 3000 K STREET NW, WASHINGTON, DC, 20007, US

(21) Appl. No.: 10/556,383

(22) PCT Filed: May 5, 2004
(86) PCT No.: PCT/GB04/01938

§ 371 Date: Jan. 10, 2006

(30) Foreign Application Priority Data
May 13, 2003 (GB) 0310943.6

(51) Int. Cl. H01J 49/00

(52) U.S. Cl. 250/292

(57) ABSTRACT

An IMS system has a cell (1, 101) with an inlet (2) at one end by which gas or vapour to be analysed can be supplied to the cell. A selective barrier (6) in the cell allows selected molecules to pass into an ionisation region (7) and the ions produced then pass into a drift region (9) via a gate (8). The ions drift along the cell (1, 101) to a collector (11) and provide an electrical output. A system (40, 140) supplies cleaned, dried air to the opposite end (30) of the cell (1, 101) to flow along it against the flow of the ions. The system (40) includes a doped molecular sieve (41), which continuously adds a first reagent to the air for combination with selected ions in the cell. The system (40) also has additional reservoirs (42, 43, 44) of further, different reagents, which are switched selectively to supply to the air in addition to the first reagent when indicated by the cell output, such as to combine with an interferent ion.

This invention relates to ion mobility spectrometer systems of the kind including an IMS cell having an inlet for supplying a vapour or gas to be analysed to the cell.

IMS systems are often used to detect substances such as explosives, drugs, blister and nerve agents or the like. An IMS system typically includes a detector cell to which a sample of air containing a suspected substance is supplied as a gas or vapour. The cell operates at or near atmospheric pressure and contains electrodes that are energized to produce a voltage gradient across the cell. Molecules in the sample of air are ionized, such as by means of a radioactive source or by corona discharge, and are admitted into the drift region of the cell by an electrostatic gate at one end. The ionized molecules drift to the opposite end of the cell at a speed dependent on the size of the ion. By measuring the time of flight across the cell it is possible to identify the ion. It is common practice to add a reagent or dopant to the cell. The reagent is selected so that it combines with the substance of interest to produce a larger molecule that moves more slowly and can be more readily distinguished from other substances.

Examples of IMS systems are described in GB 2324407, GB 2324875, GB2316490, GB2323165 and U.S. Pat. No. 4,551,624. U.S. Pat. No. 6,459,079 describes a system with a positive and a negative cell, which are each supplied with a different reagent. U.S. Pat. No. 6,495,824 describes a system where one of several different reagents can be supplied to the cell in response to detection of a suspect substance. US2002088936 describes an IMS system having a molecular sieve for drying and cleaning recirculated gases, which is impregnated with a dopant.

Existing systems may suffer from various disadvantages such as complexity and slow speed of response.

It is an object of the present invention to provide an alternative MS system.

According to one aspect of the present invention there is provided an ion mobility spectrometer system of the above-specified kind, characterised in that the system also includes both a source of a first reagent for continuous supply to the cell such that the vapour or gas supplied to the cell is exposed to the first reagent, and a source of a further reagent different from the first reagent for supply to the cell only intermittently.

The system is preferably arranged to supply the further reagent to the cell in response to an output from the cell indicative of the presence of a substance with which the further reagent combines. The further reagent may be selected to enable identification of an interfering substance. The source of the first reagent may include a doped sieve. The reagents are preferably supplied to the cell independently of the vapour or gas to be analysed. The vapour or gas to be analysed may be supplied to the cell on opposite sides of a selective barrier. The source of the first reagent may include a sieve unit, the source of the further reagent including a plurality of reservoirs containing a plurality of further reagents different from the first reagent, and the system including a series connection between the sieve unit, the reservoirs and the cell such that gas can be supplied to the cell either via the sieve unit directly or via one or more of the reservoirs.

According to another aspect of the present invention there is provided a method of operating an ion mobility spectrometer including the steps of supplying a vapour or gas to be analysed to an IMS cell, supplying a first reagent to the cell continuously, in response to a first output from the cell indicative of the suspected presence of a predetermined substance, supplying a further reagent different from the first reagent to the cell in addition to the first reagent such as to produce a second output from the cell that confirms or refutes the presence of the predetermined substance.

An IMS system according to the present invention, will now be described, by way of example, with reference to the accompanying drawings:

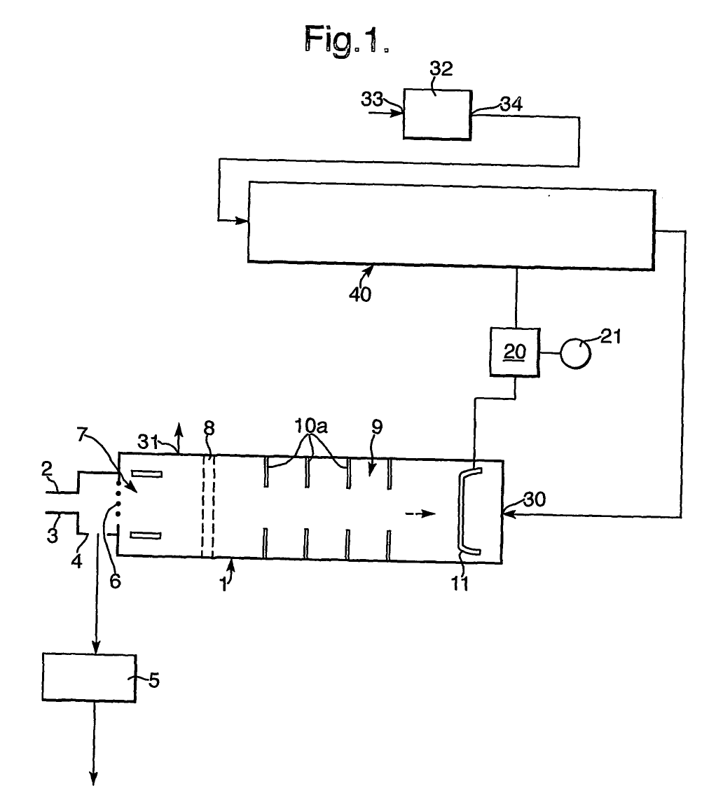

FIG. 1 is a schematic diagram of the system with an external air supply;

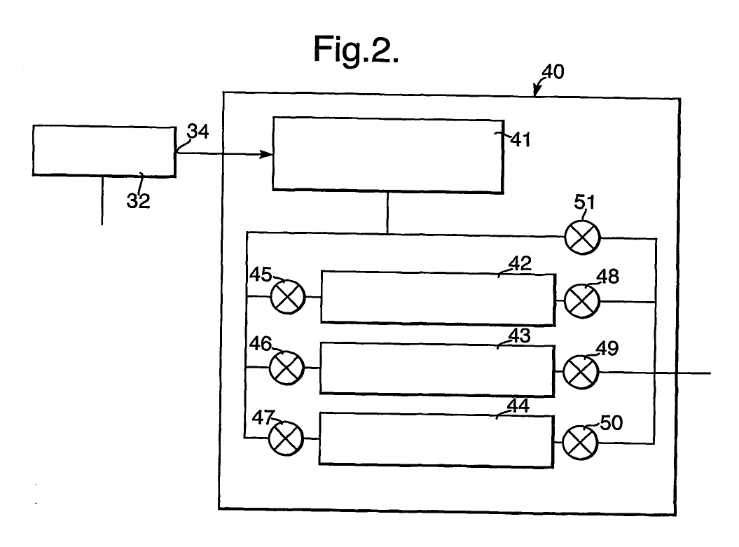

FIG. 2 shows a part of the system in greater detail; and

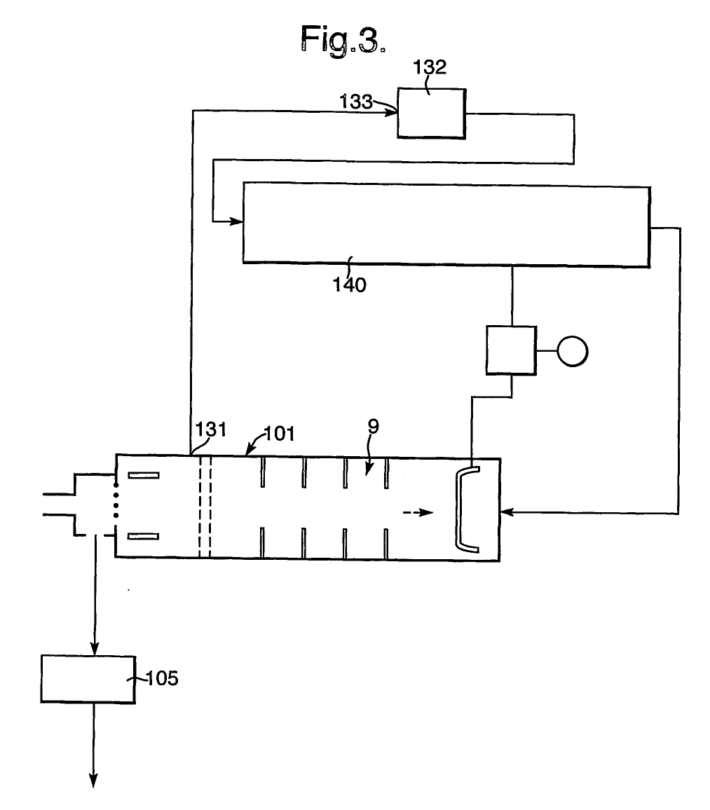

FIG. 3 is a schematic diagram of an alternative system with a recirculating air supply.

With reference first to FIGS. 1 and 2, the system includes an IMS drift cell 1 having an inlet manifold 2 with an inlet port 3 and an exhaust port 4. Sample air to be analysed is supplied to the inlet port 3. The exhaust port 4 is connected to atmosphere via a pump 5. The interior of the manifold 2 opens into the left-hand end of the interior of the cell via a selective barrier 6. The barrier 6 maybe a pinhole, as described in WO93/01485, or a semi-permeable membrane, or of any other form that allows passage of the molecules of interest whilst excluding the majority of other molecules. Instead of a barrier, the sample to be analysed may be supplied to the cell 1 by some other interface, such as of the kind described in EP 596978.

The barrier 6 communicates with an ionisation region 7 provided by an ionisation source such as a radiation source or a corona discharge. To the right of the ionisation region 7 a Bradbury Nielson gating grid 8 controls passage of ionised molecules into a drift region 9 formed by a series of drift electrodes 10. A collector plate 11 at the right-hand end of the cell collects ions passed through the drift region 9 and provides an output to a processor 20, which also controls the gate 8 and various other functions of the system. The processor 20 provides an output to a display 21 or other utilisation means indicative of the nature of the sample.

At its right-hand end, the cell 1 has an inlet 30, by which air is supplied to the interior of the cell where it travels from right to left and flows out to atmosphere via an exhaust outlet 31 close to the gating grid 8 in the ionisation region 7. Air is supplied to the inlet 30 by means of a pump 32 having an inlet 33 open to atmosphere and an outlet 34 connected to the cell inlet 30 via an air drying/cleaning/doping system 40.

The air drying/cleaning/doping system 40 is shown in greater detail in FIG. 2. The system 40 includes a doped molecular sieve 41, of the kind described in US2002088936, one side of which is connected to the outlet 34 of the pump 32. The sieve 41 functions to clean and dry the air and is preferably doped with a suitable reagent so that air flowing through the sieve picks up small amounts of the reagent. The outlet of the sieve 41 connects either directly to the cell or via a parallel arrangement of a plurality of dopant sources, such as represented by the three chambers or sources 42, 43 and 44, via a respective one of three valves 45, 46 and 47. The outlet of each dopant source 42 to 44 connects with the cell inlet 30 via respective valves 48, 49 and 50. A valve 51 allows direct flow from the sieve 41 to the cell 1 when opened. The sieve 41 and dopant sources 42 to 44 are each a reservoir for a reagent substance; the reagents in the sieve and sources are each different from one another. The reagents are selected according to the substances the IMS system has been arranged to detect.

The valves 45 to 47, 48 to 50 and 51 are remotely controlled by the processor 20. The valves are controlled so that air can flow through one, two or all three dopant sources 42, 43, and 44 or directly from the sieve. Thus, for example, valves 45 and 48 might be open to allow flow through the source 42, with all the other valves 46, 47, 49 and 50 being closed to prevent flow through the other sources 43 and 44. Alternatively, for example, valves 45, 47, 48 and 50 might be open so that air collects reagents from the sources 42 and 44. A suitable switching protocol for the valves under software control allows flushing of the dopant chambers. Where the sieve 41 is also doped, it can be seen that the air supplied to the cell 1 at the inlet 30 always contains reagent from the sieve. Except where the valve 51 is opened, the air also contains reagent from any combination of one, two or three further of the sources 42 to 44, so that between one and four different reagents can be supplied to the cell 1. The reagents carried into the cell 1 interact with the molecules passed through the barrier 6. It will be appreciated that the number of dopant sources could be greater or less than that described. Where the sieve 41 is not doped, the sample supplied to the cell can be exposed to only one reagent, or to two or three reagents in different combinations.

The normal mode of operation of the system might be with the valves 45 and 48 open so that the molecules in the sample air supplied to the inlet manifold 2 are exposed to the dopants in the sieve 41 and in the source 42. If the processor 20 detects a peak indicating the possible presence of the substance being monitored, it opens, for example, valves 46 and 49 to allow the reagent in source 43 to enter the cell 1. This may cause a different peak to be produced indicative of the presence of an interfering substance, in which case the system does not generate an alarm. If, however, no such peak is produced, the processor 20 interprets this as indicating that the initial peak is indicative of the presence of the monitored substance and hence gives an alarm on the display.

It will be appreciated that there are various other ways of operating the system. For example, the reagents might be selected so that the presence of an additional peak when the additional reagent is added confirms the presence of the substance being monitored and the absence of such a peak refutes its presence.

The system shown in FIG. 3 is very similar to that in FIG. 1 so equivalent components have been given the same reference number with the addition of 100. Instead of supplying atmospheric air to a cleaning/drying/doping system, as in the arrangement of FIG. 1, the system shown in FIG. 3 is a recirculating system where the inlet 133 of the pump 132 is connected to the outlet 131 at the left-hand end of the cell 101. The drying/cleaning/doping system 140 is exactly the same as the system 40 described above and the system functions in the same manner as described above.

Because the sample is continuously exposed to at least one dopant, the construction and operation of the system is simplified. Also, the response can be quicker than in a system where the dopant is only switched in when there is some indication of the presence of a particular substance. Adding the dopant to the air in the cell, rather than to the sample carrier gas also enables the system to be simplified. By supplying the reagent directly to the cell independently of the gas to be analysed or its carrier gas, the cell itself is doped and ion exchange is limited to the drift region of the cell, which can enable a shorter detection time than when the sample gas or its carrier alone is doped.

1. An ion mobility spectrometer system including an IMS cell having an inlet for supplying a vapor or gas to be analyzed to the cell, wherein the system also includes both a source of a first reagent for continuous supply to the cell such that the vapor or gas supplied to the cell is exposed to the first reagent, and a source of a further reagent different from the first reagent for supply to the cell only intermittently.

2. A system according to claim 1, wherein the system is arranged to supply the further reagent to the cell in response to an output from the cell indicative of the presence of a substance with which the further reagent combines.

3. A system according to claim 1, wherein the further reagent is selected to enable identification of an interfering substance.

4. A system according to claim 1, wherein the source of the first reagent includes a doped sieve.

5. A system according to claim 1, wherein the reagents are supplied directly to the cell independently of the vapor or gas to be analyzed.

6. A system according to claim 1, wherein the vapor or gas to be analyzed is supplied to the cell on opposite sides of a selective barrier.

7. A system according to claim 1, wherein the source of the first reagent includes a sieve unit that the source of the further reagent includes a plurality of reservoirs containing a plurality of further reagents different from the first reagent, and that the system includes a series connection between the sieve unit, the reservoirs and the cell such that gas can be supplied to the cell either via the sieve unit directly or via one or more of the reservoirs.

8. A method of operating an ion mobility spectrometer including the steps of supplying a vapor or gas to be analyzed to an EMS cell, supplying a first reagent to the cell continuously, in response to a first output from the cell indicative of the suspected presence of a predetermined substance, supplying a further reagent different from the first reagent to the cell in addition to the first reagent such as to produce a second output from the cell that confirms or refutes the presence of the predetermined substance.
